(19) United States
(12) Patent Application Publication
(10) Pub. No.: US 2026/0245808 A1
(43) Pub. Date: Aug. 20, 2026

(54) Electrical Contact with Multilayer Coating

(71) Applicants: ABB Schweiz AG, Baden (CH); NANESA S.R.L., Roma (IT)

(72) Inventors: Su Zhao, Västerås (SE); Anna Andersson, Västerås (SE); Erik Johansson, Västerås (SE); Gabriele Bartolini, Norcia (IT); Lorenzo Fabbri, Bucine (IT); Emanuele Piciollo, Montevarchi (IT); Martti Juhani Taimisto, Vaasa (FI); Francesco Bertocchi, Roma (IT)

(21) Appl. No.: 19/152,574

(22) PCT Filed: Feb. 3, 2023
(86) PCT No.: PCT/EP2023/052711

§ 371 Date: Jul. 31, 2025

(51) Int. Cl. H01H 1/02; H01H 1/42; H01H 11/00

(52) U.S. Cl. CPC H01H 1/02; H01H 1/42; H01H 11/00

(57) ABSTRACT

The present disclosure relates to an electrical contact including a substrate of an electrically conductive metallic material and a multilayer non-silver coating directly on a surface of the substrate. The multilayer coating includes an electrically conductive composite layer consisting of particles of a Graphene and Related Materials (GRM) material in a metal matrix, and a metallic top layer directly on top of the composite layer.

### TECHNICAL FIELD

The present disclosure relates to an electrical contact comprising a substrate of an electrically conductive metallic material and an electrically conductive non-silver coating arranged directly on a surface of the substrate.

### BACKGROUND

In switch-disconnectors, electrical contacts are used. These are exposed both to electrical wear, via the electric arc during making/breaking, and mechanical wear, as the moving contact slides against the stationary contact during the transition between arcing area and main contact area. Both moving and stationary contacts are made of silver (Ag)-plated copper (Cu). Ag-plating is used to protect the copper from surface oxidation.

However, silver plating is expensive and sensitive to sulphur pollution. Also, the most reliable and widely used process of silver deposition is cyanide silver plating, which relies on using and disposing of highly toxic cyanide baths.

There are several issues with using grease lubrication, e.g. evaporation and loss of grease over time, wear particles getting stuck in the grease, degradation that leads to higher viscosity, and at high temperatures (e.g. at arcing) grease decomposes and dries out forming a resistive film. These instabilities will eventually lead to increased contact resistance and overall temperature increase of the switching device. Also, an increased force may be needed to operate the device.

Lubricants with long-term thermal stability and corrosion resistance are not readily available. Solid-lubricant additives, like graphite or MoS₂, require a trade-off between mechanical/tribological and electrical properties.

CN 111519232 discloses use of a silver-graphene coating on top of a pure silver coating on a copper base metal of an electrical contact, to prevent sulfurization and corrosion of the silver-plated contact. The pure silver coating separates the base metal from the silver-graphene coating, thus preventing internal oxidation by the sulphur and oxygen in the base metal.

CN 112553616 discloses a surface protection method for an electrical contact of an isolating switch. The surface of the high-voltage isolating switch electrical contact is sequentially deposited, by laser deposition, with a graphene-copper composite coating and a diamond-copper composite coating.

### SUMMARY

It is an objective of the present invention to provide an improved electrical contact. More specifically, it is an objective to provide an improved silver-fee and dry contact (i.e. without need for grease).

According to an aspect of the present invention, there is provided an electrical contact comprising a substrate of an electrically conductive metallic material and a multilayer non-silver coating directly on a surface of the substrate. The multilayer (ML) coating comprises an electrically conductive composite layer consisting of particles of a Graphene and Related Materials (GRM) material in a metal matrix, and a metallic top layer directly on top of the composite layer.

According to another aspect of the present invention, there is provided an electrical switch comprising an embodiment of the electrical contact of the present disclosure.

According to another aspect of the present invention, there is provided a method of coating a substrate of an electrically conductive metallic material for an electrical contact. The method comprises providing a metal-GRM electrolytic solution comprising GRM particles and metal ions and depositing a composite layer on a surface of the substrate by electrodeposition whereby the GRM particles and metal ions are co-deposited to form an electrically conductive metal-GRM composite layer directly on the surface. The method also comprises, providing a metal electrolytic solution comprising metal ions, and depositing a top layer on the composite layer by electrodeposition whereby the metal ions are deposited to form a metallic top layer directly on top of the composite layer.

By including graphene (G) or other GRM material in the multilayer (ML) coating of an electrical contact, the friction coefficient can be substantially reduced, whereby grease lubrication may no longer be needed. The graphene may thus provide a self-lubricating property to the coating. The graphene also improves the resistance to corrosion and heat, allowing the contact to better withstand arcing. The composite coating may still retain electrical conductivity, and low resistance, allowing the contact to be used as an electrically conducting contact, especially when the GRM content is low e.g. below 1 percent by weight (wt %) of the composite layer of the coating.

The top layer can further protect the composite layer from corrosion, e.g. oxidation. For instance, a nickel top layer has been shown to efficiently protect a copper metal matrix from oxidation, presumably by oxidation of the nickel (forming nickel oxides) instead of the copper. Preferably, the top layer is relatively thin, e.g. having an average thickness of less than 1 micrometre (μm) whereby the top layer may crack upon making contact with another contact of a contact pair in an electrical switch, exposing the composite layer such that the lubricating properties of the GRM particles may still be exhibited on a surface of the contact, already in the initial stage of use.

It follows that the ML coating may exhibit similar electrical contact resistance as an Ag reference but with lower friction, higher oxidation resistance and good endurance performance.

The ML coating comprising a metal-GRM (Me-GRM) layer could also be cheaper than silver plating on copper. The lifecycle cost of a Cu-graphene coating may be about 50% lower compared to Ag plating. The cost benefits are mainly related to materials costs and elimination of disposal costs for cyanide-based solutions in the case of Ag plating.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first,” second,” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic circuit diagram of an electrical switch, e.g. of a switchgear, in accordance with some embodiments of the present invention.

FIG. 2a is a schematic side view of an electrical contact, in accordance with some embodiments of the present invention.

FIG. 2b is a schematic side view of a multilayer coating of an electrical contact, in accordance with some embodiments of the present invention.

FIG. 3 is a schematic sectional side view of an electrodeposition bath, in accordance with some embodiments of the present invention.

FIG. 4 is a schematic flow chart of some embodiments of a method of the present invention.

FIG. 5 is an example graph of a standard pin-on-disc reciprocal test at 5 Newton (N) comparing friction of an embodiment of the ML coating of the present invention and a standard greased solution versus a spherical Ag counter surface.

FIG. 6 is an example graph showing contact resistance over time for an embodiment of the ML coating of the present invention at 10 N and 30 N compared with copper and silver references, also at 10 N and 30 N.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

In accordance with the present invention, a metal-GRM composite is used. Graphene and Related Materials (GRM) include graphene (G), graphene oxide (GO), reduced GO (rGO) and any combination thereof. Thus, when GRM is mentioned herein, any such material is covered by the term. Herein the term graphene (G) is used collectively for carbon atoms in a 2D-honeycomb lattice in the form of mono-layer sheets, bi-layer sheets, few (3-5 layers)-layer sheets, or nano-platelets having an average, e.g. number average, thickness of at most 50 nm, e.g. within the range of 0.3-50 nm. Also, when graphene is discussed herein, it should be understood that some of the graphene may be in the form of graphene oxide (GO) or reduced GO (rGO). Thus, the graphene or GRM may be pure graphene or comprise a mixture of pure graphene and GO and/or rGO. Preferred GRM particles are graphene nanoplatelets (GnP), e.g. having an average, e.g. number average, thickness within the range of 5-50 nm.

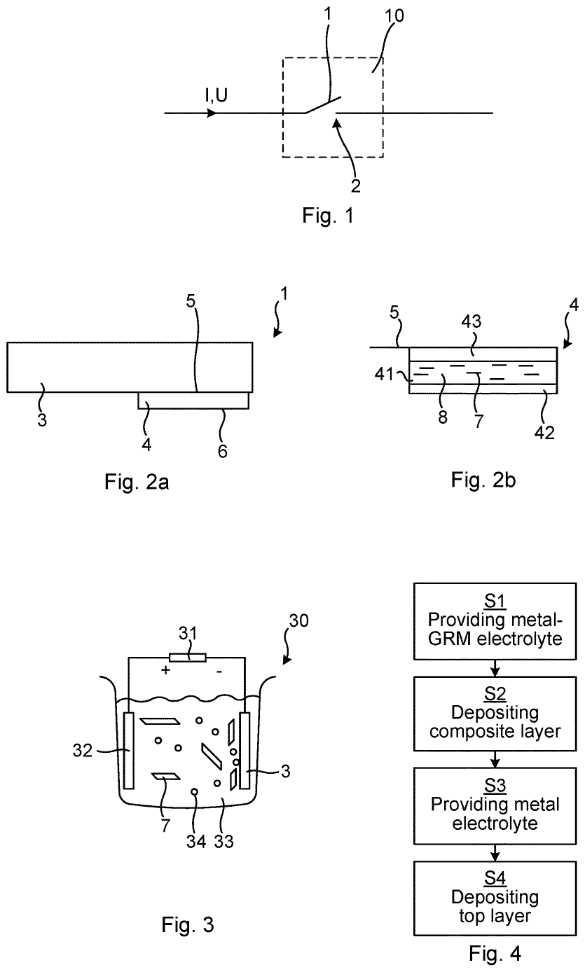

FIG. 1 illustrates an electrical switch 10, typically a switchgear, e.g. a switch-disconnector, arranged for switching an electrical current I having a voltage U, alternating current (AC) or direct current (DC), comprising a contact arrangement 2 comprising a contact 1, typically of at least a pair of contacts in the contact arrangement 2 e.g. comprising a pair of contacts of which one is a stationary contact and another is a moving contact arranged to slide onto and off the stationary contact. Thus, the contact 1 may be a sliding contact, e.g. a knife contact. In a specific example, the contact 1 may be a stationary knife contact, e.g. of a switch-disconnector 10, arranged for sliding against a moving contact, but in other embodiments the contact 1 may be any suitable type of contact. In some embodiments, the sliding contact 1 is arranged to be squeezed between two parts of a moving contact arranged for rotating on/off the stationary electrical contact 1. If the electrical contact 1 is an arcing contact, it is arranged for handling arcing e.g. at an edge of the contact 1.

The switch 10 is preferably for low voltage (LV) applications, having a nominal AC voltage of at most 1 kV, e.g. within the range of 0.1-1 kV, or a nominal DC voltage of at most 1.5 kV, e.g. within the range of 0.1-1.5 kV, or for applications of higher nominal voltages, having a nominal AC or DC voltage within the range of 1-70 kV, preferably LV applications. Thus, the switch 10, and thus the contact 1, may be configured for a nominal AC voltage of at most 1 kV or a nominal DC voltage of at most 1.5 kV.

The contact arrangement 2, and thus the contact 1 thereof, may be configured to be conducting, meaning that the contact 1 is arranged for conducting the current I when the switchgear 10 is closed (conducting). The contact 1 should thus have low resistance and high conductivity. The contact arrangement 2, and thus the contact 1, may also be arcing during closing and/or opening of the switch 10, being able to withstand an arc formed therein, especially if the switchgear is arranged for LV or MV applications, but not high voltage (HV) applications. Thus, in some embodiments, the contact 1 is an arcing (and typically also conducting) contact, part of an arcing contact arrangement 2 of the switch 10. In some embodiments, the switch 10 may be or comprise a swich-disconnector, configured for ensuring that an electrical circuit to which it is connected can be de-energized.

The coating 4 may provide an arcing edge 6 (see FIG. 2a) of the contact 1, if the contact is an arcing contact.

The coating 4 is arranged on the substrate 3, typically on a surface 5 of the substrate such that the coating 4 is in direct contact with the electrically conductive material of the substrate 3. The electrically conductive material of the substrate 3 may be metallic, e.g. comprising or consisting of (typically consisting of) Cu or aluminium (Al), preferably Cu.

The coating 4 may, e.g. for a sliding contact 1, form a tribofilm on the contact surface during sliding. This solution gives a coefficient of friction vs. a pure Ag counter surface in the range 0.15-0.25, the same level compared to conventional greased Ag—Ag contacts.

The coating 4 is preferably made by electrodeposition (also called electroplating), but other coating methods such as cold spraying, and laser sintering or oven sintering, are also possible.

FIG. 2b illustrates embodiments of the ML coating 4. The ML coating 4 comprises a composite layer 41 of a GRM particles 7 in a metal matrix 8. The non-Ag metal of the matrix should be electrically conductive and may typically be or comprise (preferably consist of) Cu. The composite layer 41 may have an average thickness of at most 100 μm, e.g. within the range of 10-50 μm, preferably 15-20 μm.

The GRM content in the composite layer 41 may be within the range of 0.1 to 3 or 2 wt %, preferably within the range of 0.3 to 1.5 or 1 wt %, thus being a concentration which substantially improves the electrical properties of the contact 1 while still providing self-lubricating properties as well as improved wear resistance and resistance to arcing and high temperatures. The contact resistance of the ML coating may be close to the same as for pure Ag-plating. Well-dispersed GRM particles 7 result in an arc-erosion effect and weld resistance, typically at an arcing edge 6 of the coating 4, that is much improved over pure Ag. The multifunctionality of the coating 4 makes it ideal for an arcing LV contact 1 e.g. of a switch-disconnector. Preferably, the composite layer 41 may consist of only GRM and Me, with the GRM particles 7 dispersed within the Me matrix 8.

The GRM 7 is preferably present as few-layer graphene sheets 7 (also called graphene nanoplatelets, GnP, herein), with a preferable thickness within the range of 1-50 nm. The GRM sheets 7 each has a lateral size, herein discussed as a longest diameter, which is several times larger than the thickness, resulting in the platelet form (could also be called a flake or sheet form). In some embodiments, the GRM sheets 7 each has a longest diameter within the range of 5-80 μm. The GRM sheets 7 may prevent diffusion of atoms (e.g. Cu) of the substrate 3 through the coating 4, which is a known problem when using e.g. pure Ag coatings, further preventing corrosion on the surface of the coated contact 1.

The metallic top layer 42 of the coating 4 is arranged directly on top of the composite layer 41 and may protect the metal of the matrix 8 in the composite layer 41 from corrosion, specifically oxidation in ambient air but possibly also other corrosion such as acid corrosion. Typically, the top layer 42 consists of metal, a pure metal or a metal alloy, plus any metal oxides resulting from oxidation of the said metal. The metal of the top layer may be pure copper or nickel, preferably nickel, or a copper and/or nickel alloy. An advantage with nickel, especially when the metal of the matrix 8 is copper, is that the top layer nickel is oxidated instead of the matrix copper, protecting the composite layer 41 from oxidation. An advantage with copper in the top layer 42 may be improved adhesion to the copper matrix 8.

The top layer 42 is preferably substantially thinner than the composite layer 41. The top layer 42 is preferably thin enough to not significantly reduce the lubricating effect of the composite layer 41 for the contact 1. In some embodiments, the top layer 42 has an average thickness of at most 1 μm, e.g. within the range of 400-700 nm. Any thickness discussed herein may be determined by means of e.g. Scanning Electron Microscope (SEM) such as back-scattered electrons (BSE) SEM.

As mentioned above, it may in many cases be preferred that the composite layer 41 is arranged directly onto the surface 5 of the substrate 3. However, in some embodiments, the ML coating 4 may also comprise a base layer 43 arranged between the composite layer 41 and the substrate 3, typically such that the base layer 43 is arranged directly on the surface 5 of the substrate 3 and the composite layer 41 is arranged directly on top of the base layer 43. Such a base layer may protect the metal of the substrate 3 against corrosion, e.g. oxidation, especially in cases where the metal of the substrate 3 differs from the metal of the matrix 8. For example, if the substrate is Al and the matrix is Cu, a base layer 43 of Cu or Ni may suitably be used. In addition to providing corrosion resistance, an intermediate base layer 43 may improve adhesion of the composite layer 41 to the substrate 3. The base layer 43 may have an average thickness within the range of 1-10 μm. In some embodiments of the present invention, the multilayer coating 4 comprises a base layer 43 arranged directly on the surface 5 of the substrate 3, wherein the composite layer 41 is arranged directly on top of the base layer 43, preferably wherein the base layer is of nickel or copper, e.g. consisting of metallic nickel and, optionally, nickel oxides.

FIG. 3 illustrates an electrodeposition arrangement or bath 30 for electrodeposition of the layers of the coating 4.

For the composite layer 41, an example Me-GRM electrolytic solution 33, typically aqueous, comprises GRM particles 7, typically in the form of GnP, and Me ions 34. The substrate 3 functions as a cathode and is, together with a corresponding anode 32, connected to a voltage source 31. The anode 32 may e.g. be a copper (sacrificial) anode or an inert anode of mixed oxides. By applying a voltage, by the voltage source 31, between the substrate 3 and the anode 32, the GRM particles 7 and Me ions 34 are co-deposited onto a surface 5 of the substrate 3 to form the composite layer 41. The Me ions 34 are typically provided by dissolving a metal salt, e.g. a copper salt such as CuSO₄ and/or CuCl₂ in the electrolytic solution 33. In some embodiments, the metal salt content in the solution 33 is within the range of 50 -250 grams per litre (g/L). An example electrolytic solution 33 for the composite layer 41 comprises CuSO4 50-300 g/L, CuCl2 10-400 ppm, graphene 0.01-10 g/L, dispersing agent 0.01-10 g/L. The GRM content in the solution 33 may preferably be within the range of 0.01-1.5 g/L.

Similarly, for the top layer 42 (and also any base layer 43), an example metal electrolytic solution 33, typically aqueous, comprises Me ions 34 (but no GRM particles 7). The substrate 3 functions as a cathode and is, together with the corresponding anode 32, connected to a voltage source 31. By applying a voltage, by the voltage source 31, between the substrate 3 and the anode 32, the Me ions 34 are deposited (and reduced) on top of the composite layer 41 on the substrate 3 to form the top layer 42 of metal. Again, the Me ions 34 are typically provided by dissolving a metal salt, e.g. a nickel salt or a copper salt such as CuSO₄ and/or CuCl₂ in the electrolytic solution 33. In some embodiments, the metal salt content in the solution 33 is within the range of 50 -250 grams per litre (g/L). An example electrolytic solution 33 for the top layer 42 comprises CuSO4 50-300 g/L, CuCl2 20-250 ppm, H2SO4 10-200 g/L.

FIG. 4 illustrates some embodiments of a method of coating a substrate 3 of an electrically conductive non-silver material for an electrical contact 1. The method comprises, providing S1 a metal-GRM electrolytic solution 33 comprising GRM particles 7 and metal ions 34, and depositing S2 a composite layer 41 on a surface 5 of the substrate 3 by electrodeposition whereby the GRM particles 7 and metal ions 34 are co-deposited to form an electrically conductive metal-GRM composite layer 41 directly on the surface 5. Then, the method also comprises, providing S3 a metal electrolytic solution 33 comprising metal ions 34, and depositing S4 a top layer 42 on the composite layer 41 by electrodeposition whereby the metal ions 34 are deposited to form a metallic top layer 42 directly on top of the composite layer 41.

FIG. 5 shows an example graph of a standard pin-on-disc reciprocal test at 5 Newton (N) comparing friction of an embodiment of the ML coating of the present invention and a standard greased solution. As can be seen, a similarly low friction is obtained by means of the ML coating 4 of the present invention as with conventional grease.

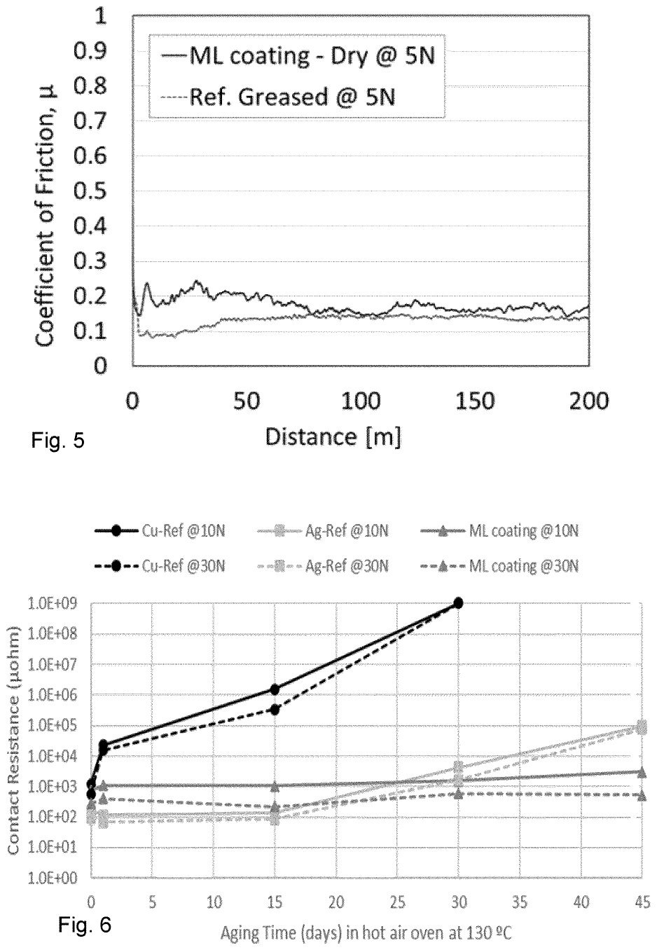

FIG. 6 shows an example graph showing contact resistance over time for an embodiment of the ML coating of the present invention at 10 N and 30 N compared with copper and silver references, also at 10 N and 30 N. As can be seen, there is almost no aging of the ML coating 4 of the present invention. Superior low contact resistance is obtained and maintained compared with the copper and silver references.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. An electrical contact comprising a substrate of an electrically conductive metallic material and a multilayer non-silver coating directly on a surface of the substrate, wherein the multilayer coating comprises:
an electrically conductive composite layer consisting of particles of a Graphene and Related Materials, GRM, material in a metal matrix, wherein the GRM material is graphene, graphene oxide, reduced graphene oxide or any combination thereof; and
a metallic top layer directly on top of the composite layer, wherein the top layer is of nickel or a nickel alloy and, optionally, nickel oxides, wherein the top layer has a thickness of at most 1 μm.

2. The electrical contact of 1, wherein the top layer has a thickness within the range of 400-700 nm.

3. The electrical contact of 1, wherein the metal matrix is of copper.

4. The electrical contact of claim 1, wherein the composite layer is arranged directly on the surface of the substrate.

5. The electrical contact of claim 1, wherein the multilayer coating comprises a base layer arranged directly on the surface of the substrate, wherein the composite layer is arranged directly on top of the base layer, preferably wherein the base layer is of nickel or copper, e.g. consisting of metallic nickel and, optionally, nickel oxides.

6. The electrical contact of claim 1, wherein the GRM content in the composite layer is within the range of 0.1 to 3 wt %, preferably 0.3 to 1.5 wt %.

7. The electrical contact of claim 1, wherein the particles are in the form of sheets having a thickness within the range of 0.3-50 nm, e.g. graphene nanoplatelets, GnP, having a thickness within the range of 5-50 nm.

8. The electrical contact of claim 1, wherein the composite layer has a thickness within the range of 10-50 μm, preferably 15-20 μm.

9. The electrical contact of claim 1, wherein the substrate material is or comprises copper and/or aluminium, preferably wherein the substrate material is copper.

10. An electrical switch comprising at least one electrical contact including a substrate of an electrically conductive metallic material and a multilayer non-silver coating directly on a surface of the substrate, wherein the multilayer coating includes:
an electrically conductive composite layer consisting of particles of a Graphene and Related Materials, GRM, material in a metal matrix, wherein the GRM material is graphene, graphene oxide, reduced graphene oxide or any combination thereof; and
a metallic top layer directly on top of the composite layer, wherein the top layer is of nickel or a nickel alloy and, optionally, nickel oxides, wherein the top layer has a thickness of at most 1 μm.

11. The electrical switch of claim 10, configured for applications with a nominal AC or DC voltage of at most 70 kV, e.g. low voltage applications.

12. The electrical switch of claim 10, wherein the electrical contact is a sliding contact, e.g. a knife contact.

13. A method of coating a substrate of an electrically conductive metallic material for an electrical contact including a substrate of an electrically conductive metallic material and a multilayer non-silver coating directly on a surface of the substrate, wherein the multilayer coating includes:
an electrically conductive composite layer consisting of particles of a Graphene and Related Materials, GRM, material in a metal matrix, wherein the GRM material is graphene, graphene oxide, reduced graphene oxide or any combination thereof; and
a metallic top layer directly on top of the composite layer, wherein the top layer is of nickel or a nickel alloy and, optionally, nickel oxides, wherein the top layer has a thickness of at most 1 μm, the method comprising:
providing a metal-GRM electrolytic solution including GRM particles and metal ions;
depositing a composite layer on a surface of the substrate by electrodeposition whereby the GRM particles and metal ions are co-deposited to form an electrically conductive metal-GRM composite layer directly on the surface;
providing a metal electrolytic solution comprising nickel ions; and
depositing a top layer on the composite layer by electrodeposition whereby the nickel ions are deposited to form a metallic top layer directly on top of the composite layer, where top layer has a thickness of at most 1 μm.

14. The electrical contact of claim 2, wherein the metal matrix is of copper.

15. The electrical contact of claim 2, wherein the composite layer is arranged directly on the surface of the substrate.

16. The electrical contact of claim 2, wherein the multilayer coating comprises a base layer arranged directly on the surface of the substrate, wherein the composite layer is arranged directly on top of the base layer, preferably wherein the base layer is of nickel or copper, e.g. consisting of metallic nickel and, optionally, nickel oxides.

17. The electrical contact of claim 2, wherein the GRM content in the composite layer is within the range of 0.1 to 3 wt %, preferably 0.3 to 1.5 wt %.

18. The electrical contact of claim 2, wherein the particles are in the form of sheets having a thickness within the range of 0.3-50 nm, e.g. graphene nanoplatelets, GnP, having a thickness within the range of 5-50 nm.

19. The electrical contact of claim 2, wherein the composite layer has a thickness within the range of 10-50 μm, preferably 15-20 μm.

20. The electrical contact of claim 2, wherein the substrate material is or comprises copper and/or aluminium, preferably wherein the substrate material is copper.
